(19) United States
(12) Patent Application Publication
(10) Pub. No.: US 2006/0157522 A1
(43) Pub. Date: Jul. 20, 2006

(54) Cover for safety helmet

(76) Inventor: Hung-Chih Cheng, Sanchung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/034,817

(22) Filed: Jan. 14, 2005

(51) Int. Cl. B62J 9/00; B60R 11/00

(52) U.S. Cl. 224/413; 224/572

(57) ABSTRACT

This invention relates to a cover for safety helmet comprising a cover wrapping a safety helmet, the cover is made of a waterproof cloth, of which the edge of opening is sewed with an annular flexible supporting strip by a machine, another opening is provided on a position of the cover corresponding to a buckle of the safety helmet so that when the helmet is hanged onto a motorcycle, the cover may be put around the safety helmet and a buckle of the safety helmet is made to pass through the opening and is then hanged onto the motorcycle; next, the supporting strip is then folded to have the edge of opening of the cover fully wrap the opening of safety helmet so that the safety helmet may be protected from water, dust, and sunlight.

### FIELD OF THE INVENTION

This invention relates to a cover for safety helmet and particularly to a device that may completely (tightly) wrap and keep a safety helmet from water, dust, and sunlight.

### BACKGROUND OF THE INVENTION

Conventionally, a rider generally hangs a safety helmet onto a motorcycle after parking in a proper place, and the rider fixes the helmet to the motorcycle using a seat cushion of the motorcycle in order to take the helmet nearby fixed on the motorcycle when the rider rides the motorcycle next time.

However, if the motorcycle is parked outdoors, the safety helmet is easily damaged from wear and tear of the weather or stained with dust so that its service life is shortened; especially, if the inner pad of safety helmet is fully wet with rains, the rider cannot wear it instantly to ride, and hence a convenient, portable cover for safety helmet must actually be designed and developed for improvement of the defects mentioned above.

### SUMMARY OF THE INVENTION

In consideration of the mentioned-above defects of prior art, the inventor researches for various solutions to the former defects with concentrated effort depending on the experiences and accumulated techniques in manufacturing of various covers for headgears, and after the constant research, the test, and the improvement, the inventor finally designs and develops a brand-new cover for safety helmet according to this invention for removal of the defects of prior art.

This invention is to provide a cover for safety helmet, the cover is made of a waterproof cloth, of which the edge of opening is sewed with an annular flexible supporting strip, and another opening is provided on a position of the cover corresponding to a buckle of the safety helmet.

When the helmet is hanged onto a motorcycle, the cover may put around the helmet and the buckle of the helmet is made to pass through another opening and is hanged onto the motorcycle; like this, the supporting strip is then folded to have the edge of opening of the cover fully wrap the opening of safety helmet so that the safety may be protected from water, dust, and sunlight.

We hope that you, the examiner, can further figure out the object, figure, features and performance of this invention, so we give embodiments in conjunction with the accompanying drawings and make a detailed description as follows.

### BRIEF DESCRIPTION OF THE DRAWINGS

FIG. 1 is a schematic view illustrating the appearance of a cover according to this invention.

FIG. 2 is a schematic view illustrating the appearance of the cover according to this invention wrapping a safety helmet.

FIG. 3 is a schematic view illustrating the appearance of a cover collected according to this invention.

FIG. 4 is a schematic view of another embodiment of this invention.

### DETAILED DESCRIPTION OF THE PREFERRED EMBODIMENTS

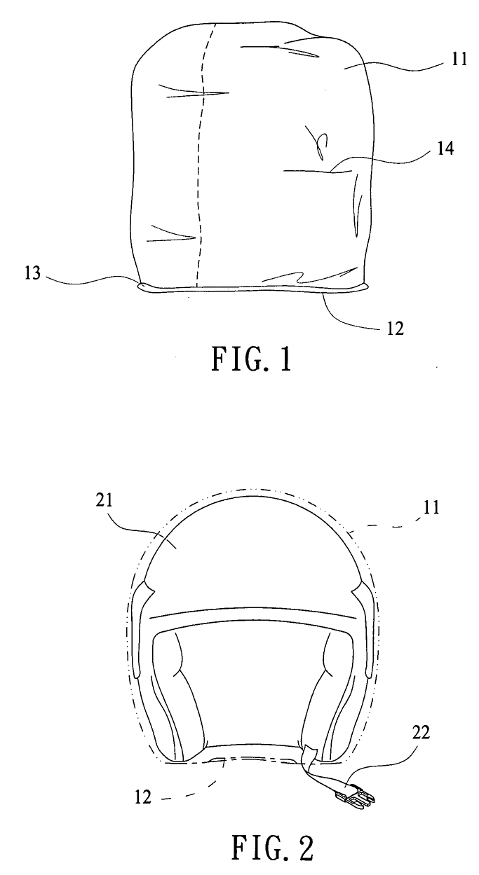

This invention relates to a cover for safety helmet, referring now to FIGS. 1 and 2, comprising a cover body 11 wrapping a safety helmet, in which the body 11 is made of a waterproof cloth, of which the edge of opening 12 is sewed with an annular flexible supporting strip 13 by a machine, and another opening 14 is provided on a position of the body 11 corresponding to a buckle 22 of the safety helmet 21.

When the safety helmet 21 is hanged onto a motorcycle, the body 11 may be put around the helmet 21 and the buckle 22 of the helmet 21 is made to pass through another opening 14 and is then hanged onto the motorcycle; like this, the supporting strip 13 is then folded to have the edge of opening 12 of the body 11 fully wrap the opening of safety helmet 21 so that the safety helmet 21 may be protected from water, dust, and sunlight.

Further referring now to FIGS. 1 and 2, after a water cloth is cut and tailored into a cover of long cylinder, the cover is made to wrap various safety helmets.

Next referring now to FIGS. 1 and 2, after a water cloth is clipped and stuck (by way of hot glue or ultrasonic waves in this embodiment but not limited for actual implement in this invention) into a cover of long cylinder, the cover is made to wrap various safety helmets.

Again referring now to FIGS. 1 and 2, the upper and lower ends of another opening 14 of the body 11 are respectively provided with a sticky flake (not shown), such as a magic felt so that when the buckle 22 of the safety helmet 21 is made to pass through another opening 14, the opening 14 may be sealed through felting of the sticky flake for prevention of water, such as rains, and dust from entering.

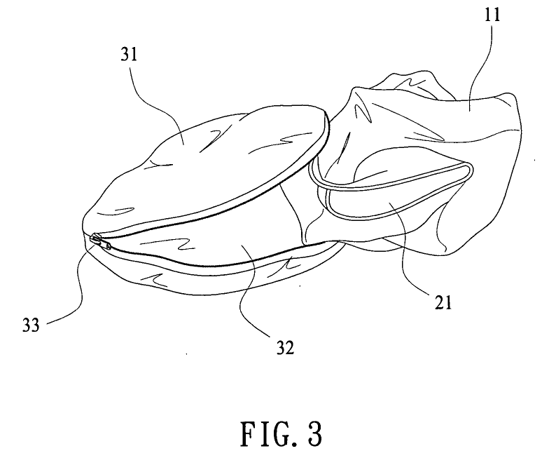

Referring now to FIG. 3, the body 11 of cover is provided with a small, round cloth sheath 31 having an opening 32 on which a zipper 33 is installed to turn and fold the supporting strip 13 so that the volume of body 11 is reduced and then collected in the cloth sheath 31, thereby portability of the cover being achieved.

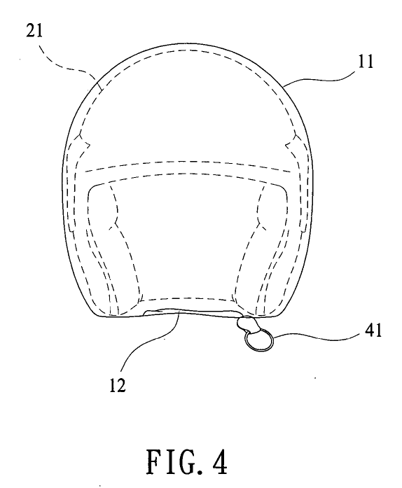

Referring now to FIG. 4, in another embodiment of this invention, a cover body 11 wrapping a safety helmet 21, in which the body 11 is made of a waterproof cloth, of which the edge of opening 12 is sewed with an annular flexible supporting strip 13, and a retaining workpiece 41, such as a retaining ring, is provided at a side of the body 11.

When the safety helmet 21 is hanged onto the motorcycle, the body 11 may be put around the safety helmet 21 and then the buckle 41 is then used to hang onto the motorcycle; like this, the supporting strip 13 is then folded to have the edge of opening 12 of the body 11 fully wrap the opening of safety helmet 21 so that the safety helmet 21 may be protected from water, dust, and sunlight.

To sum up, an innovative structure of the cover for safety helmet according to this invention is indeed unprecedented and has not been published and has not been similar to any other product in the market; accordingly, it is surely new and original. Additionally, the unique characteristics and functions of this invention is not far parallel to the conventional one, and thus it is much more advanced than the conventional one and also meets the requirements of application for a new-type patent, and hence we apply following the patent law. In the description mentioned above, only the detailed description and drawings of the preferred embodiments according to this invention are provided without limit to this invention and the characteristics of this invention; all those skilled in the art without exception should include the equivalent changes and modifications as falling within the true scope and spirit of the present invention.

What is claimed is:

1. A cover for safety helmet comprising:
a body for wrapping a safety helmet, the body being made of a waterproof cloth, the edge of opening of the body being sewed with an annular flexible supporting strip by a machine;
when the safety helmet being hanged onto a motorcycle, the body being suitably put around the safety helmet and the supporting strip being then folded to have the edge of opening of the body fully wrap the opening of safety helmet.

2. The cover for safety helmet according to claim 1, wherein another opening is provided on a position of the body corresponding to a buckle of the safety helmet and when the safety helmet is hanged onto the motorcycle, the body may be put around the helmet and the buckle of the safety helmet is made to pass through another opening and is then hanged onto the motorcycle; next, the supporting strip is folded to have the edge of opening of the body fully wrap the opening of safety helmet.

3. The cover for safety helmet according to claim 2, wherein after the water cloth is cut and tailored into the cover of long cylinder, the cover is made to wrap various safety helmets.

4. The cover for safety helmet according to claim 2, wherein the water cloth is cut and tailored into the cover of long cylinder so that the cover is made to wrap various safety helmets.

5. The cover for safety helmet according to claim 2, wherein the upper and lower ends of another opening of the body are respectively provided with a magic felt so that when the buckle of the safety helmet is made to pass through the opening, the opening may be sealed through felting of the magic felt.

6. The cover for safety helmet according to claim 2, wherein the cover is provided with a small, round cloth sheath having an opening on which a zipper is installed to fold the supporting strip so that the volume of cover is reduced and then collected in the cloth sheath.

7. The cover for safety helmet according to claim 1, wherein a retaining workpiece is provided at a side of the body and when the safety helmet is hanged onto the motorcycle, the body may be put around the safety helmet and the retaining workpiece of the safety helmet is then hanged onto the motorcycle; next, the supporting strip is folded to have the edge of opening of the body fully wrap the opening of safety helmet.
